(19) United States
(12) Patent Application Publication
(10) Pub. No.: US 2018/0200871 A1
(43) Pub. Date: Jul. 19, 2018

(54) T-SHAPED RATCHET WRENCH WITH AUXILIARY ROTARY SOCKET

(71) Applicant: Jun-Tsai Shyu, Taichung (TW)

(72) Inventor: Jun-Tsai Shyu, Taichung (TW)

(21) Appl. No.: 15/410,729

(22) Filed: Jan. 19, 2017

(51) Int. Cl. B25B 23/00; B25B 13/46

(52) U.S. Cl. CPC B25B 23/0035; B25B 13/462

(57) ABSTRACT

A T-shaped ratchet wrench with an auxiliary rotary socket includes a wrench body formed by a holding and force applying section and an action section with a plug end, a ratchet direction control device installed at the joint of the holding and force applying section and the action section for setting the driving and operating direction of the wrench when a force is applied, a quick release assembly installed at a position near an end of the action section and conformed with the plug end to provide the effect of snapping or releasing an external socket quickly, and an auxiliary rotary socket installed at the top of the quick release assembly in the action section of the wrench body and capable of rotating freely and pivotally to facilitate and accelerate the operation of screwing a screw.

### BACKGROUND OF THE INVENTION

### (a) Field of the Invention

The present invention relates to a T-shaped ratchet wrench with an auxiliary rotary socket, more particularly to the T-shaped ratchet wrench capable of setting a driving and moving direction for an applying force by a ratchet direction control device, accelerating a screwing or rotating operation, and improving the practicality of the T-shaped wrench.

### (b) Description of the Related Art

The so-called “auxiliary rotary socket” generally refers to an accessory installed to some hand tools, and the auxiliary rotary socket comes with an assembly that can be pivotally rotated freely to facilitate users to hold the auxiliary rotary socket by one hand and gently tap on a force applying section of the hand tool by the other hand in order to accelerate the screwing and rotating operation during the screwing and rotating operation (or after a secured screw is loosened or before a screw is secured), and such convenient operation is well received and extensively used by users.

However, such conventional auxiliary rotary socket is just applicable to a conventional T-shaped wrench only, but not applicable to a professional T-shaped ratchet wrench. Obviously, the practicality of the professional auxiliary rotary socket is reduced, and the conventional auxiliary rotary socket requires improvements.

### SUMMARY OF THE INVENTION

Therefore, it is a primary objective of the present invention to provide an auxiliary rotary socket of a T-shaped ratchet wrench capable of improving its practicality and performance without increasing the manufacturing cost or complicating the manufacturing procedure significantly.

According to the invention, a T-shaped ratchet wrench with an auxiliary rotary socket includes a wrench body formed by a holding and force applying section and an action section with a plug end, a ratchet direction control device installed at the joint of the holding and force applying section and the action section for setting the driving and operating direction of the wrench when a force is applied, a quick release assembly installed at a position near an end of the action section and conformed with the plug end to provide the effect of snapping or releasing an external socket quickly, and an auxiliary rotary socket installed at the top of the quick release assembly in the action section of the wrench body and capable of rotating freely and pivotally to facilitate and accelerate the operation of screwing a screw.

### BRIEF DESCRIPTION OF THE FIGURES

FIG. 1 is an exploded view of a preferred embodiment of the present invention;

FIG. 2 is a partial cross-sectional view of an auxiliary rotary socket installed to an action section in accordance with the present invention;

FIG. 3 is a perspective view of the assembly as depicted in FIG. 1;

FIG. 4 is a schematic view of a using status after an external socket is inserted as depicted in FIG. 3;

FIG. 5 is an exploded view of another preferred embodiment of the present invention; and

FIG. 6 is an exploded view of an auxiliary rotary socket in accordance with another preferred embodiment of the present invention.

### DETAILED DESCRIPTION OF THE PREFERRED EMBODIMENT

The present invention will now be described in more detail hereinafter with reference to the accompanying drawings that show various embodiments of the invention.

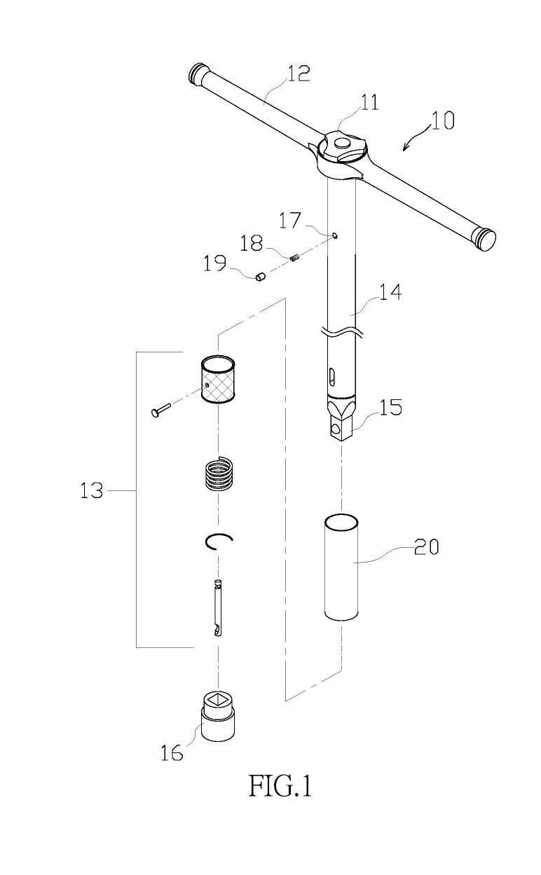

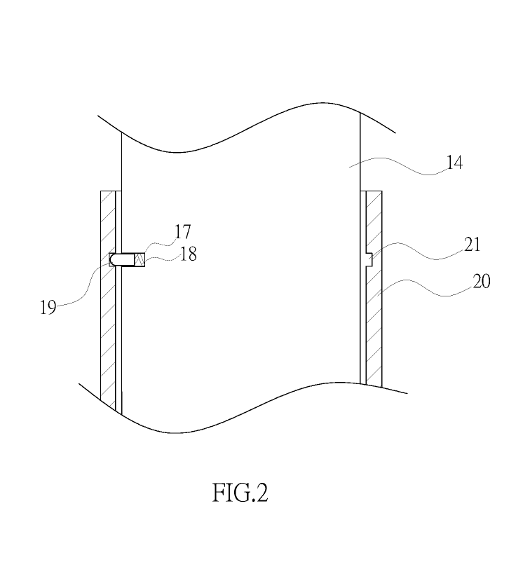

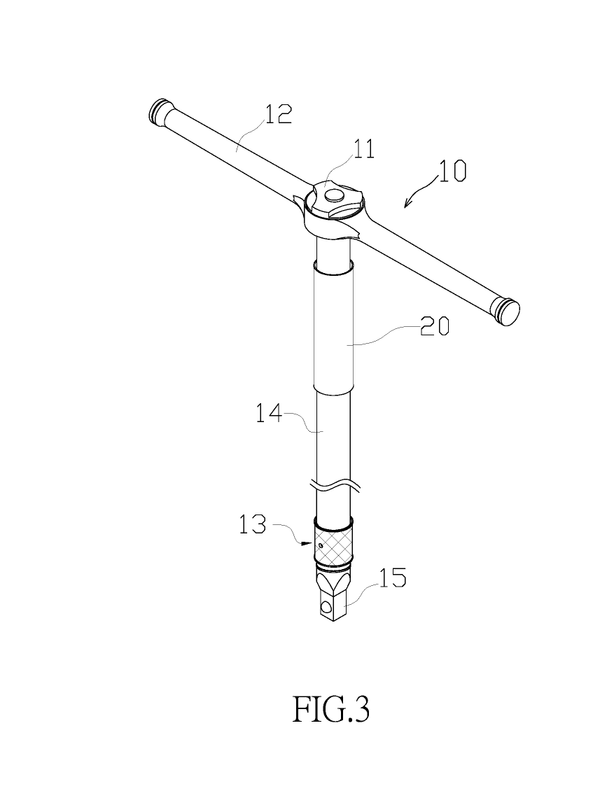

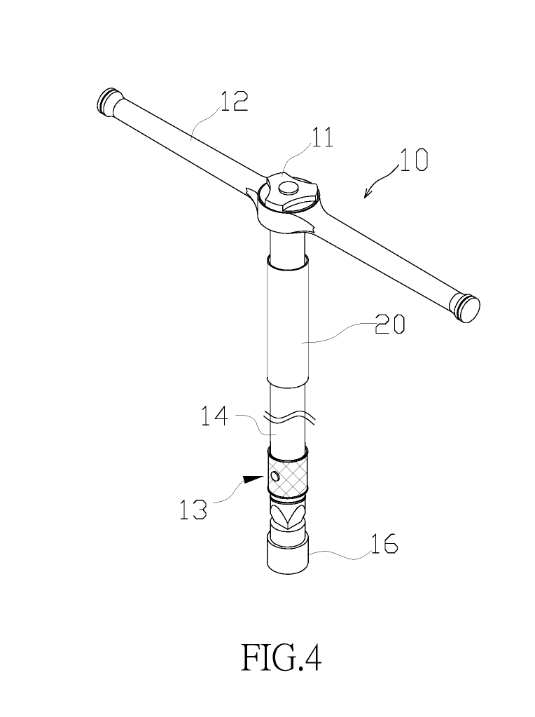

With reference to FIGS. 1 to 4 for an auxiliary rotary socket applied to an integral T-shaped ratchet wrench in accordance with a preferred embodiment of the present invention, the integral T-shaped ratchet wrench 10 comprises a ratchet direction control device 11 having a transverse holding and force applying section 12 disposed at the center of the ratchet direction control device 11 and a longitudinal action section 14 of a quick release assembly 13 disposed at the bottom of the quick release assembly 13 wherein the bottom of the action section 14 is a plug end 15 for inserting and connecting an external socket 16, and then at least one small-diameter round hole 17 is formed at an appropriate position of the action section 14 of the integral T-shaped ratchet wrench 10 for installing a corresponding quantity of pushing springs 18 and latch members 19, so that the pushing spring 18 abuts the latch member 19 outward constantly, and then a corresponding inner-ring notch 21 is formed at a predetermined position of the hole periphery of the hollow auxiliary rotary socket 20, such that after the action section 14 is inserted into the auxiliary rotary socket 20, a user just needs to press and retreat the latch member 19 to release the latch member after an inner peripheral surface of the auxiliary rotary socket 20 has passed through the latch member 19 and continue the insertion, so as to achieve the effects of latching the inner-ring notch 21, sheathing the auxiliary rotary socket 20 easily, and positioning the auxiliary rotary socket 20 at a predetermined position of the action section 14 easily.

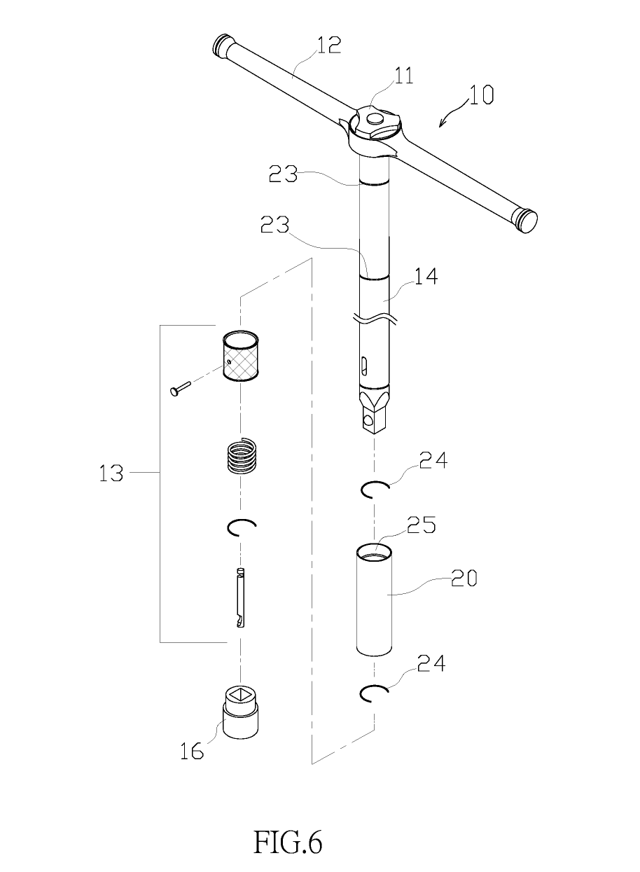

It is noteworthy that all components of the quick release assembly 13 are removed as shown in FIGS. 1 and 6 for the purpose of describing the assembling procedure of the auxiliary rotary socket 20. In this preferred embodiment, the auxiliary rotary socket 20 is assembled first before all quick release assemblies 13 are installed one by one to comply with the original structural design of this product. However, it is not absolutely necessary for the present invention to be used together with the quick release assembly 13 before producing the expected effects. The components of the quick release assembly 13 and their assemblies are removed for the purpose of describing the sequence of installation, but they do not affect the overall using performance of the present invention, and thus will not be described in details. In addition, the ratchet direction control device 31 is a conventional component, and its effect and performance are well known and thus will not be described here.

Of course, one or more sets of small-diameter round holes 17 and corresponsive pushing springs 18 and latch members 19 may be added to make the auxiliary rotary socket 20 more stable and prevent it from being shaken. For example, these components may be installed at a predetermined position such as the front, rear, left or right of the action section 14 according to the actual requirement. However, the present invention is not just limited to the aforementioned arrangement only.

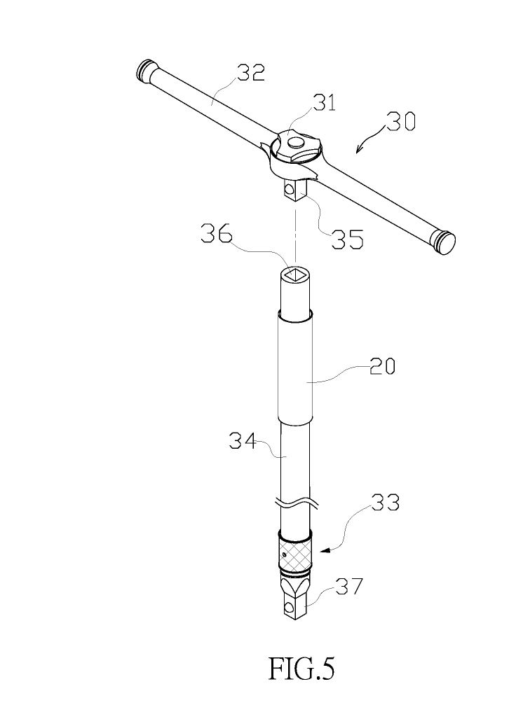

With reference to FIG. 5 for an auxiliary rotary socket applied to a detachable T-shaped ratchet wrench in accordance with another preferred embodiment of the present invention, the detachable T-shaped ratchet wrench 30 comprises a transverse wrench body 32 having a ratchet direction control device 31 installed at the center of the wrench body 32 and a longitudinal action rod 34 externally connected and having a quick release assembly 33, wherein the other end of the ratchet direction control device 31 is a polygonal plug end 35, and a relative end of the top of the action rod 34 is a corresponding polygonal slot 36, so that the polygonal plug end 35 and the polygonal slot 36 can be used for insertion and connection. Of course, the action rod 34 also has a plug end 37 extended from the bottom of the action rod 34 and provided for inserting the external socket 16, so that the auxiliary rotary socket 20 can be sheathed easily and positioned at a predetermined position of the action rod 34 automatically to complete the assembling.

With reference to FIG. 6 for an auxiliary rotary socket 20 in accordance with another preferred embodiment of the present invention, the auxiliary rotary socket 20 includes upper and lower buckle ditches 23 formed at appropriate positions of the action section 14, and stepped inner holes 24 formed at corresponsive positions of the hollow auxiliary rotary socket 20, so that the upper and lower buckling effect of two corresponding buckles 25 may be adopted to complete the pivotal connection to achieve the same effect.

Therefore, the present invention may be installed to any T-shaped ratchet wrench that requires the use of the auxiliary rotary socket 20 without hindrance or difficulty. The present invention also provides easy installation and automatic positioning effect, and thus the invention has potential practical values.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A T-shaped ratchet wrench with an auxiliary rotary socket includes a wrench body formed by a holding and force applying section and an action section with a plug end, a ratchet direction control device installed at the joint of the holding and force applying section and the action section, a quick release assembly installed at a position near an end of the action section and conformed with the plug end to provide the effect of snapping or releasing an external socket quickly, and an auxiliary rotary socket installed at the top of the quick release assembly in the action section of the wrench body and capable of rotating freely and pivotally.

2. A T-shaped ratchet wrench with an auxiliary rotary socket, comprising:
an integral T-shaped ratchet wrench, formed by a transverse holding and force applying section and a longitudinal action section, and further comprising a ratchet direction control device installed at the center of the force applying section, a quick release assembly installed at the bottom of the action section, and a plug end disposed at the bottom of the action section; and
a hollow auxiliary rotary socket;
wherein at least one small-diameter round hole is formed at an appropriate position of the action section of the integral T-shaped ratchet wrench for installing an equal quantity of pushing springs and latch members, so that the pushing spring constantly abuts the latch member outward, and a corresponding inner-ring notch is formed at a predetermined position of a hole periphery of the auxiliary rotary socket, so that the auxiliary rotary socket may be sheathed and automatically positioned at a predetermined position of the action section.

3. A T-shaped ratchet wrench with an auxiliary rotary socket, comprising:
a detachable T-shaped ratchet wrench, formed by a transverse wrench body having a ratchet direction control device installed at the center of the wrench body and a longitudinal action rod having a quick release assembly disposed at the bottom of the action rod, and the other end of the ratchet direction control device being a polygonal plug end, and a corresponding polygonal slot being formed at the opposite end of the top of the action rod, and a plug end being extended from the bottom of the action rod; and
a hollow auxiliary rotary socket,
wherein at least one small-diameter round hole is formed at an appropriate position of the action section for installing an equal quantity of pushing springs and latch members, so that the pushing spring constantly abuts the latch member outward, and a corresponding inner-ring notch is formed at a predetermined position of a hole periphery of the auxiliary rotary socket, so that the auxiliary rotary socket may be sheathed and automatically positioned at a predetermined position of the action section.
